(19) United States
(12) Patent Application Publication
(10) Pub. No.: US 2003/0001009 A1
(43) Pub. Date: Jan. 2, 2003

(54) Collision mitigation method and apparatus used in a radio frequency identification system

(75) Inventors: Timothy J. Collins, Lockport, IL (US); Patrick L. Rakers, Kildeer, IL (US); Richard S. Rachwalski, Lemont, IL (US); Terri S. Hughes, Hanover Park, IL (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/897,513

(22) Filed: Jun. 29, 2001

(51) Int. Cl. G06F 17/60

(52) U.S. Cl. 235/385

(57) ABSTRACT

A collision mitigation method used in a radio frequency identification (“RFID”) system is disclosed. A set of information classes (100) is assigned. A communication channel is assigned to each information class. Information is received on at least a first communication channel.

The present invention relates generally to a collision mitigation method and apparatus in a radio frequency identification system.

### BACKGROUND OF THE INVENTION

In applications for identification of persons and things, bar code systems are almost universally employed. Generation of a bar code is very inexpensive to manufacture. However, a problem associated with a bar code system is that a bar code must be precisely aligned with a bar code reader in order to be read. Another problem with the bar code system is that the bar codes may become unreadable as a result of damage, for example, exposure to moisture, or wear and tear from use.

Radio frequency identification (RFID) systems address some of the shortcomings of bar code systems. RFID tags (or devices) and related readers for powering up and receiving stored information from the tags are well known. For example, U.S. Pat. No. 4,818,855 issued to Mongeon et al., titled, Identification System, discloses a RFID device which derives power from a remote source via one of an electric field or a magnetic field and which transmits stored information back to the source via the other of the electric field or magnetic field. A power source with a data collection function is known as a tag reader. A power source capable of sending data to a tag is known as a tag writer. A power source capable of bi-directional communication is known as a tag reader/writer.

An ongoing objective in the development of RFID tags and associated readers and/or writers of the general type described above has been to minimize cost and size and to improve efficiency of operation. The simplest and least expensive RFID systems employ unidirectional communication, allowing data transfer from tag to reader only. These systems are commonly known as read-only systems. In read-only systems, eliminating the need for a data receiver on the tag minimizes tag cost. Typically, these tags transmit information continuously as long as they receive adequate power from the source. The reader's receiver is capable of reliably detecting data from only one tag at a time. If multiple tags are present within the reader's field, they will simultaneously transmit and create mutual interference at the reader's receiver, preventing the data from any one tag from being recovered successfully. This mutual interference condition is commonly referred to as a data collision. The term anti-collision or collision mitigation are used to describe methods employed to prevent or minimize such data collisions at the reader.

Prior RFID tags have employed an Aloha protocol as an anti-collision mechanism. The Aloha protocol uses significant amounts of communication between the reader and the tags, which significantly increases the cost of the RFID tag. The Aloha protocol sorts through a population of RFID tags and assigns each tag a unique node address. When implementing the Aloha protocol, the reader sends out a request command to all tags in the field. The tags react to the request command by selecting a random number. This random number is used as the tag's slot number. The reader polls the tags in the field looking for response. The reader starts by polling for slot number 0. All tags that have chosen a random number of 0 respond. If exactly one tag responds, then the reader assigns a unique node address to the tag. If more than one tag responds, a collision occurs, and the reader will ignore the indecipherable response. The polling sequence proceeds with the reader polling for the next slot number. Upon reaching the end of the polling sequence, the reader can start over by requesting tags that have not been assigned a node address to select a new random number. This process continues until all tags in the field have been assigned unique node addresses. Only at this time can reliable communication with individual tags occur without a reasonable threat of collision.

A major problem with the Aloha protocol, however, is the numerous bi-directional communications, the additional circuitry, and the increased cost required to perform the random number generation at the RFID tag.

Thus, there exists a need to provide a low-cost collision mitigation method to be used in a RFID system.

### BRIEF DESCRIPTION OF THE FIGURES

A preferred embodiment of the invention is now described, by way of example only, with reference to the accompanying figures in which:

FIG. 1 illustrates an example of an organization of information classes in accordance with the present invention;

FIG. 2 illustrates an example of a simple memory map in a radio frequency identification (“RFID”) device in accordance with the preferred embodiment of the present invention;

FIG. 3 illustrates an example of a channel assignment based on the information classes in FIG. 1 in accordance with the present invention;

FIG. 4 illustrates an example of channel assignment for a time division is multiple access (“TDMA”) implementation of the present invention; and

FIG. 5 illustrates an example of a hospital application of the present invention.

### DETAILED DESCRIPTION OF THE PREFERRED EMBODIMENT

The present invention provides a low-cost collision mitigation method and apparatus to be used in a radio frequency identification (“RFID”) system. The present invention is applicable to capacitive-coupled (also referred to as electrostatic) RFID systems, inductive-coupled (also referred to as electromagnetic) RFID systems, combination capacitive/inductive-coupled RFID systems, and the like. Further, the present invention is best suited for closed RFID systems (e.g., a material management system), but is not limited to such; open RFID systems, and the like, can benefit from the advantages of the present invention. For ease of explanation, however, the following discussion will describe a closed RFID system.

A closed RFID system is a system associated with a finite number of items or types of items, and no new item or type of item can be added to the system without prior consent of the system. In other words, the system is structured based on a priori knowledge of the RFID devices used in the system. For exemplary purposes only, the following discussion describes a hospital environment as a closed system and will be referred to in various examples throughout the discussion.

In a hospital environment, there are many item categories that must be managed to allow patient care and billing to be performed properly. As illustrated in FIG. 1, the present invention assigns each item category an information class 1100. An information class 100 is a category of items/people/tests, etc. with a common purpose or function. For purposes of this example, the information classes 100 are, but not limited to, patients (information class 1) 101, doctors (information class 2) 103, nurses/technicians (information class 3) 105, and test specimens (information class 4) 107. Depending on the application, or desired features of the system, additional information classes 100 can be added to the system.

To illustrate, by example, the information classes 100 further, each patient, upon admittance into the hospital, is issued a RFID wristband. The RFID wristband is assigned to information class 1 (since it is worn by the patient), and typically contains personal information regarding the patient, such as, name, social security/identification number, current medication, medication causing known allergic reactions, etc. Likewise, each doctor and nurse/technician affiliated with the hospital wears a RFID identification badge. The RFID identification badge worn by a doctor is assigned to information class 2, and typically contains the doctor's name, identification number, specialty of practice, etc., and the RFID identification badge worn by a nurse/technician is assigned to information class 3, even though it may contain the same type of information disclosed in the badge worn by the doctor. Finally, each container used for a test specimen has a RFID label affixed thereto and is assigned to information class 4.

Alternatively, different types of doctors/nurses/test specimens or doctors/nurses/test specimens belonging to different departments can be assigned to different information classes depending on how the system is organized. For simplicity, however, regardless of type or department, all the doctors, nurses/technicians, and test specimens are classified with their respective groups.

For ease of understanding, FIG. 1 is a snapshot, in a pyramid format, of a patient's record. All of the doctors and nurses that examined or treated the patient, and all of the test specimens taken from the patient are captured in the patient's record. As stated above, each of their RFID devices is assigned to an information class 100 and communicates with the RFID system in accordance with the present invention.

FIG. 2 illustrates an example of a memory map 200 in a RFID device. As shown, the memory map 200 can be divided into read-only memory locations 201 and read-write memory locations 203. The read-only memory locations 201 typically stores information-specific data to the item associated with the RFID device. For example, the RFID wristband worn by a patient upon admittance into the hospital will store information such as the patient's name, social security/identification number, the date of admittance, or the like, into the read-only memory locations 201. The write memory locations 203 are available for typically storing application-specific data, such as, time stamp information, or the like. A channel assignment location 205 (described in detail below) is stored in the memory map 200 (either in a read-only memory location or a read-write memory location, depending on the use and application of the RFID device) so that the RFID device knows when (or over which communication channel) to transmit and/or receive data from the RFID system, and preferably, the duration of the channel assigned. Optionally, some data for communication overhead 207 may be included in the memory map 200, such as, cyclic redundancy check, for use in testing communication reliability or detection of collisions.

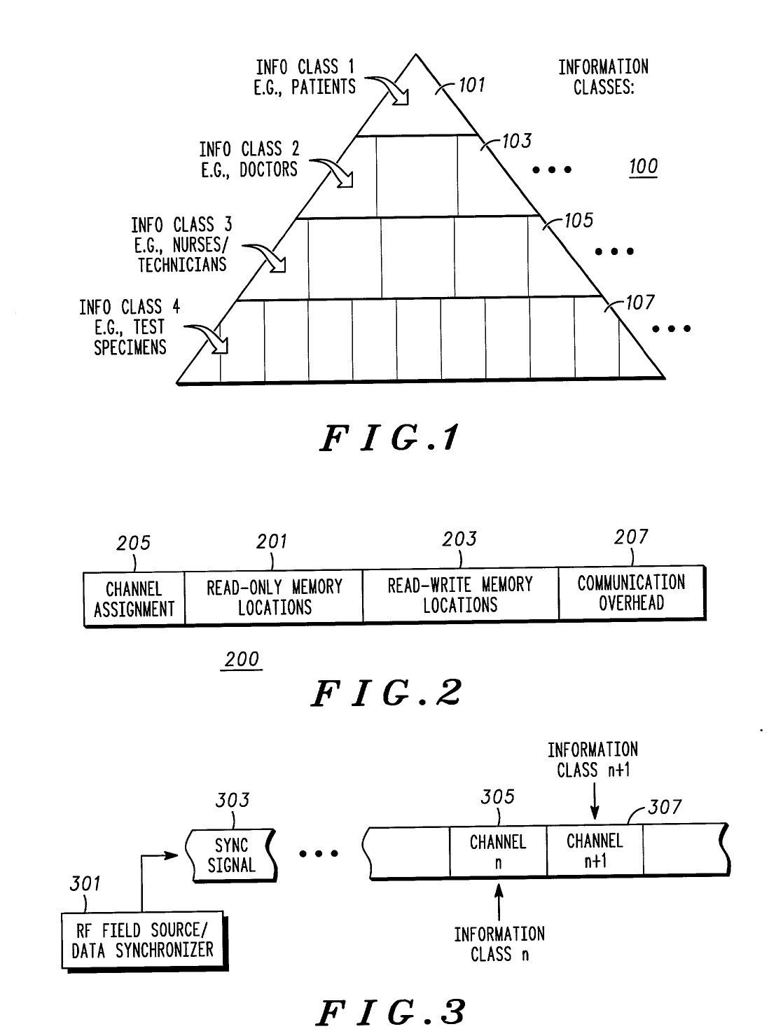

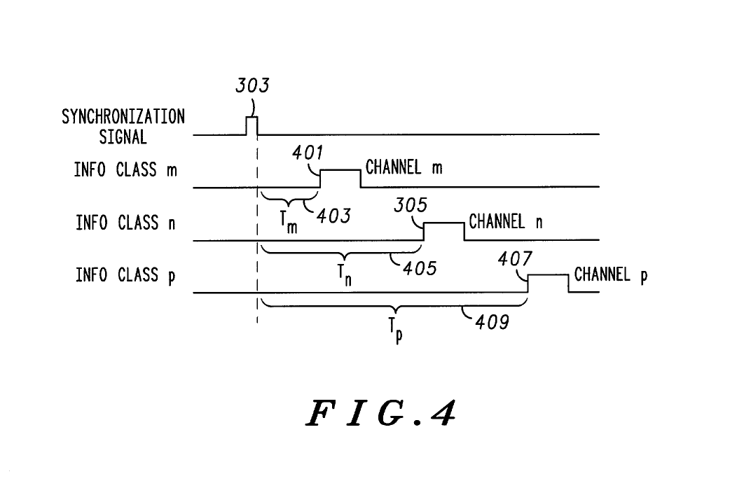

FIG. 3 illustrates an example of channel assignments based on the information classes 100 assigned in FIG. 1. A subset of the communication channels 300 is shown in FIG. 3. Preferably, the total number of communication channels available 300 in the system are greater than or equal to the number of information classes 100 assigned for the system, even if a given reader may only deal with a subset of this total number of channels as required for its function, however, the total number of communication channels can be any number.

In accordance with the present invention, each information class 100 is assigned a communication channel over which to transmit and/or receive data. For ease of simplicity and clarity, the communication channel assigned to an information class 100 corresponds to the information class number. For example, for purposes of this discussion, RFID devices/tags worn by patients (information class 1) are assigned to communicate with the system over communication channel 1; RFID devices/tags worn by doctors (information class 2) are assigned to communicate data to the system over communication 2; RFID devices/tags worn by nurses/technicians (information class 3) are assigned to communicate data to the system over communication channel 3; and RFID device/tags affixed to test specimens (information class 4) are assigned to communicate data to the system over communication channel 4. Likewise, RFID device/tags assigned to information class n are assigned to communicate data to the system over communication channel n.

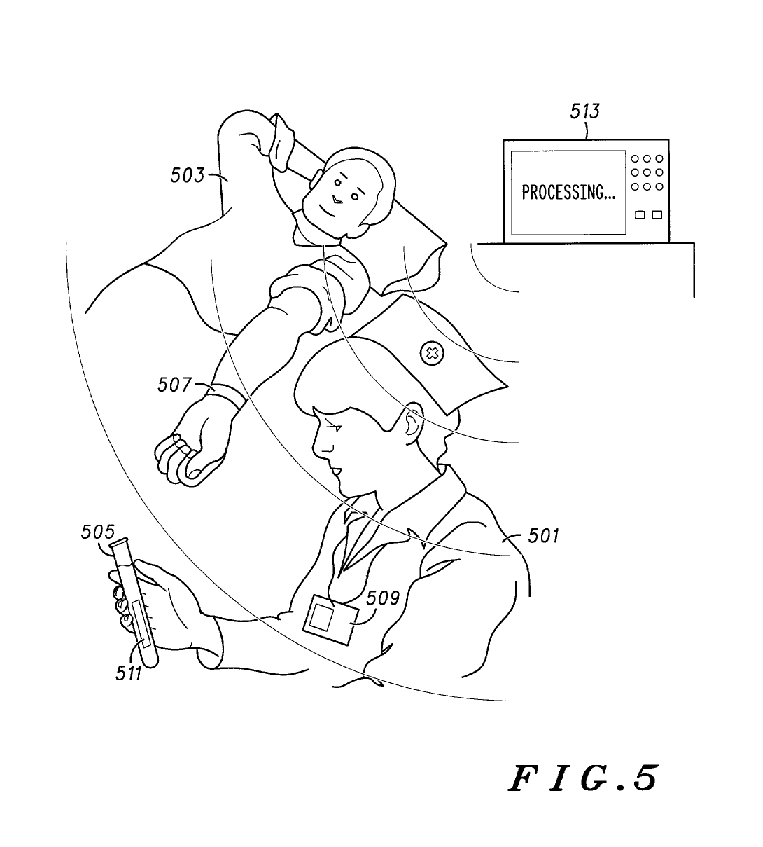

Preferably, especially in a time division multiple access (“TDMA”) system, the communication channels are non-overlapping. The quantity of information transmitted is predefined, based on the information class, to ensure that the communication channels are non-overlapping. As such, the RFID devices are required to wait for a predetermined time period to elapse, which is based on its assigned information class, before it can communicate with the system (described in further detail with reference to FIG. 4 below). Thus, in accordance with the present invention, the channel assignments of the information classes 100 help mitigate collisions between multiple tags in the RFID system.

As shown in FIG. 3, a radio frequency (“RF”) field source/data synchronizer 301, which is part of the reader function of the RFID system, referees the exchange of information between a reader and a tag. Preferably, the RF field source/data synchronizer 301 also transmits a carrier signal to power the tags (e.g., passive tags), however, the present invention is also applicable to active tags (i.e., tags having their own power source) as well.

In operation, the RF field source/data synchronizer 301 starts communication with the tags in the field by transmitting a synchronization signal 303. Upon detection of the synchronization signal 303, each tag in the field communicates its information to the reader (from either its read-only memory locations 201 or its read-write memory locations 203) or receives information from a writer (to be stored into its read-write memory locations 203) over its pre-assigned channel. Preferably, each RFID device has a priori knowledge of the duration of its assigned communication channel. In read-only systems, it is adequate to base the channel duration on the quantity of data that will be transmitted by the RFID device. In read-write systems, however, it is preferable to have the channel duration extend longer than the time it takes to transmit the data from the RFID device so that if the writer needs to store information on the RFID device, it an do so within the same communication channel. Thus, with a priori knowledge of the channel duration, the RFID device can remain active (or listen) during the entire duration of its assigned channel in order to receive information from a writer, if required.

For example, FIG. 3 shows that a RFID device assigned to information class ‘n’ would communicate data to the reader and/or receive data from a writer over communication channel n 305, and that a RFID device assigned to information class n+1 would communicate data to the reader and/or receive data from the writer over communication channel n+1 307. Since each information class 100 preferably has a unique communication channel, data collisions are significantly reduced. Thus, each RFID device communicates with the reader/writer only over its pre-assigned communication channel.

FIG. 4 further illustrates channel assignment for a time division multiple access (“TDMA”) system implementation of the present invention. Although the examples described herein refer to a TDMA system, the present invention is also applicable to frequency division multiple access (“FDMA”) systems, code division multiple access (“CDMA”) systems, and any other system having substantially orthogonal channels.

As shown in FIG. 4, the reader generates a synchronization signal 303 that instructs each RFID tag in the field to synchronize with the signal 303. Once synchronized, the RFID tag waits for a predetermined time (based on its assigned information class 100) and, after the predetermined time has elapsed, transmits and/or receives data over the communication channel.

For example, a first RFID tag in the system is assigned to information class m, and information class m is assigned to communication channel m 401. The first tag synchronizes with the synchronization signal 303, waits a first predetermined time, Tₘ, 403, and after the predetermined time, Tₘ, 403 has elapsed, transmits/receives information over channel m 401, if any.

A second tag in the system is assigned to information class n, and information class n is assigned to communication channel n 305. The second tag synchronizes with the synchronization signal 303, waits a second predetermined time, Tₙ, 405 before it transmits/receives any information. After the second predetermined time, Tₙ, 405 has elapsed, the second tag transmits/receives information over channel n 305, if any.

Finally, a third tag in the system is assigned information class p, and information class p is assigned to communication channel p 407. The third tag synchronizes with the synchronization signal 303, waits a third predetermined time, Tₚ, 409, and after the third predetermined time, Tₚ, 409 has elapsed, transmits/receives information over channel 407, if any.

It is important to note that regardless of the order in which the RFID tags synchronize with the synchronization signal 303, each RFID tag must wait a predetermined time, after synchronization with the synchronization signal 303, before it can transmit/receive information to/from the system over its assigned communication channel. The predetermined time that must elapse before transmission/reception of information is based on the information class that is assigned to the RFID tag.

The information content transmitted/received by the RFID device is preferably binary information. This binary information can be communicated over the communication channel in modulated form (i.e., as amplitude modulation of an RF carrier, as phase modulation, as quadrature amplitude modulation, or the like).

Before moving forward, discussions to this point have involved assigning a set of information classes to item categories, assigning a communication channel to each information class, and receiving data/information over a communication channel. The discussion for FIG. 5 combines these teachings in an example. As shown in FIG. 5, a phlebotomist 501 needs to draw a patient's blood in order to take a particular blood test. In accordance with the present invention, the phlebotomist 501, the patient 503, and the vial 505 each has a RFID device/tag associated therewith, and each are pre-assigned to an information class 100 as discussed above with reference to FIG. 1. To recap the previous discussion, the RFID wristband 507 worn by the patient 503 is assigned to information class 1 (and communication channel 1), the RFID identification badge 509 worn by the phlebotomist 501 is assigned to information class 3 (and communication channel 3), and the RFID label 511 affixed to the vial 505 is assigned to information class 4 (and communication channel 4).

Returning to the example illustrated in FIG. 5, after the phlebotomist 501 draws blood from the patient 503, the data stored on the RFID identification badge 509 of the phlebotomist 501, and the data stored on the RFID label 511 of the vial 505 needs to be collected and associated with the patient 503. A reader 513 transmits a synchronization signal 303 and the RFID tags 507, 509, 511 that detect the synchronization signal 303 synchronize to the signal 303. Once synchronized, the RFID tags 507, 509, 511 wait for a predetermined time to elapse, based on their assigned information class, and transmits/receives information to/from the reader/writer 513 over their assigned channel.

For example, since the RFID wristband 507 worn by the patient 503 is assigned to transmit/receive information over channel 1, upon detection of the synchronization signal 303, the RFID wristband 507 synchronizes to the signal 303, waits for a predetermined time period, T₁, to elapse, and transmits/receives information over channel 1. Likewise, the RFID identification badge 509 worn by the phlebotomist 501 synchronizes to the signal 303, waits for a predetermined time period, T₃, to elapse, and transmits/receives information over channel 3. Finally, the RFID label 511 affixed to the vial 505 synchronizes to the signal 303, waits for a predetermined time period, T₄, to elapse, and transmits/receives information over channel 4. It should be noted that in this example, there were no RFID tags that were assigned to transmit/receive information over communication channel 2 since there were no doctors present, however, the communication channel was still available and another RFID tag that was assigned to transmit/receive information over another channel was not allowed to use that channel; preferably, a RFID tag can only transmit/receive information over its assigned communication channel according to the present invention. In the preferred embodiment, the presence of multiple RFID devices assigned to a common information class could be detected through the communication overhead, such as a cyclic redundancy check. The system could signal that an error has occurred to the operator, however, it is not necessary that all of the tags be presented to the reader simultaneously.

Moving forward, when the reader 513 receives data on a communication channel, it stores the received data to a storage device location (e.g., a memory location) as a function of the communication channel over which the data was received. In a simple embodiment, there is a one-to-one correlation between the communication channel and the storage device location, however, in more complex embodiments, the function may be more complex and may result in the information being modified or altered in some manner. For example, in the simple embodiment, after the reader receives the data over communication channel 1, it copies the received data and stores the data to a storage device location as a function of communication channel 1.

The storage device location could be located locally on the reader 513, on a database, on a tag/device, or the like. In some applications, it is advantageous to store information of a first RFID device to a second RFID device. For example, it may be desirable to store the various test performed, and their results, onto the RFID wristband or other RFID device, such as an identification card or medical card, of the patient for mobile access of the patient's recent medical history. Having a portable medical history may be advantageous to the patient when determining dates of tests or immunizations performed for school, out-of-country travel, etc.

Another example for storing information from a first RFID device to a second RFID device is that after the patient is released from the hospital, relevant information stored on his/her RFID wristband (e.g., current medications, medications causing allergic reactions, primary caregiver, etc.) can be transferred to a RFID device that can be taken home with the patient, such as an identification/medical card or medical bracelet/necklace. The RFID device can then be presented on demand to provide a synopsis of the patient's medical history. For example, the portable RFID device can be presented to a doctor prescribing a new prescription that could possibly have an adverse interaction with another medication the patient is current taking; the RFID device can be presented to a caregiver (e.g., ambulance medic) providing treatment to a person who is unconscious or unable to communicate; the RFID device can be presented to a pharmacist filling a prescription to check for adverse drug interactions, etc.

There are numerous applications that can take advantage of the teachings of the present invention. For example, increased/enhanced quality control can be obtained by implementing the present invention in a RFID system since the system allows for positive identification of an item associated with a RFID device. For example, a cellular telephone is packaged in a carton with accessories and a manual. It is necessary to ensure that all of these items are present in the carton before shipping to a retailer or consumer. If each item in the carton is tagged with a RFID device and assigned a unique information class, the reader can verify that all of the items on the invoice list are contained within the carton based upon the information detected over the respective communication channels.

Further, this same system of positive identification of an item associated with a RFID device can also be used for securing documents/computer files. In this example, a RFID device would contain the encryption code used to decrypt a file stored in a secure computer file. The reader would require an employee to present his RFID badge to the reader along with the RFID device containing the encryption code. The system would read each item in the field to ensure that the appropriate individual is unlocking the encrypted file before granting access to the file. Optionally, the system could also store the identification number of the employee onto the RFID device containing the encryption code, thus creating a log of the individual who accessed the document.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

We claim:

1. A collision mitigation method used in a radio frequency identification (“RFID”) system comprising the steps of:
establishing a set of information classes;
assigning a communication channel to each information class; and
receiving data on at least a first communication channel.

2. The method of claim 1 further comprising the step of storing the received data to a storage device location as a function of the communication channel over which the data was received.

3. The method of claim 2 wherein the storage device location is located on one of the following devices: a host computer, a reader, a writer, a RFID device, a label, and a database.

4. The method of claim 1 wherein the radio frequency identification system is a closed system.

5. The method of claim 1 further comprising the step of assigning a RFID device an information class for communication with at least one of a reader and a writer.

6. The method of claim 1 further comprising the step of transmitting a signal used to power a RFID device.

7. The method of claim 1 further comprising the step of transmitting a signal in which a RFID device synchronizes to.

8. The method of claim 1 further comprising the step of transmitting a plurality of communication channels that are used by RFID devices for at least one of data transmission and data reception.

9. The method of claim 1 wherein the step of assigning utilizes a time division multiple access technology.

10. The method of claim 1 wherein the step of assigning utilizes a frequency division multiple access technology.

11. The method of claim 1 wherein the step of assigning utilizes a code division multiple access technology.

12. The method of claim 1 further comprising the step of synchronizing a RFID device for communication with at least one of a reader and a writer.

13. The method of claim 1 further comprising the step of indicating that an error has occurred when a plurality of devices attempt to transmit data on a single channel.

14. The method of claim 1 further comprising the step of indicating that an error has occurred when a plurality of devices belonging to a common information class is within a read range of a reader.

15. A collision mitigation method used in a radio frequency identification (“RFID”) system comprising the steps of:
transmitting a plurality of communication channels;
receiving data on at least a first communication channel; and
storing the received data in a storage device location as a function of the communication channel over which the data was received.

16. The method of claim 15 further comprising the step of:
establishing a set of information classes; and
assigning a communication channel to each information class.

17. The method of claim 16 further comprising the step of assigning a RFID device an information class for communication with at least one of a reader and a writer.

18. The method of claim 15 wherein the storage device location is located on one of the following devices: a host computer, a reader, a writer, a RFID device, a label, and a database.

19. An apparatus for use in a radio frequency identification system comprising:
a receiver for receiving data on at least a first communication channel; and
a storage device, coupled to the receiver, for storing the received data as a function of the communication channel over which the data was received.

20. The apparatus of claim 19 further comprising a processor, coupled to the receiver, for assigning a set of information classes and assigning a communication channel to each information class.
